(19) United States
(12) Patent Application Publication
(10) Pub. No.: US 2022/0085563 A1
(43) Pub. Date: Mar. 17, 2022

(54) METHOD OF MANUFACTURING FEMALE TERMINAL

(71) Applicant: Yazaki Corporation, Tokyo (JP)

(72) Inventors: Hiroshi FUJITA, Shizuoka (JP); Hideki Mizuno, Shizuoka (JP)

(73) Assignee: Yazaki Corporation, Tokyo (JP)

(21) Appl. No.: 17/468,933

(22) Filed: Sep. 8, 2021

(30) Foreign Application Priority Data
Sep. 11, 2020 (JP) 2020-152545

(51) Int. Cl. H01R 43/16; H01R 11/11; H01R 4/18; H01R 43/048

(52) U.S. Cl. CPC H01R 43/16; H01R 43/048; H01R 4/183; H01R 11/11

(57) ABSTRACT

A method of manufacturing a female terminal includes: (i) forming a cutout part with a predetermined width in a direction intersecting with an axial direction of a tubular member, on a part of a first tubular portion located at a side of one end of the tubular member, crushing the first tubular portion to form an electric wire connection portion, and forming as a terminal contact portion a second tubular portion located at a side of the other end of the tubular member, and (ii) electrically connecting a core wire exposed from an end of an electric wire to the electric wire connection portion.

### CROSS-REFERANCE TO RELATED APPLICATIONS

The present application is based on, and claims priority from Japanese Patent Application No. 2020-152545, filed on Sep. 11, 2020, the entire contents of which are incorporated herein by reference.

### TECHNICAL FIELD

The disclosure relates to a method of manufacturing a female terminal.

### BACKGROUND

As a method of manufacturing a crimp terminal having one end with a cylindrical crimping portion and the other end with a plate-like connection portion, there has been known one disclosed in Patent Document 1 (JP6326320). In the method of manufacturing the crimp terminal disclosed in Patent Document 1, the crimp terminal is manufactured by hollowing a solid cylindrical member at one end of the solid cylindrical member to form a bottomed cylindrical electric wire insertion hole, and by performing press rolling of the solid cylindrical member into a plate shape at the other end of the solid cylindrical member to form a connection portion of a battery terminal.

### SUMMARY

However, the conventional method of manufacturing the crimp terminal requires the hollowing of the solid cylindrical member to form the electric wire insertion hole, which increases a manufacturing cost. In addition, since a bottomed cylindrical portion is used as the electric wire insertion hole, a plating solution stagnates when this portion is plated, which prevents a plated layer from being uniformly formed on this portion.

The disclosure has been made in view of such a conventional problem, and it is an object of the disclosure to provide a method of manufacturing a female terminal that can reduce a manufacturing cost to lower a cost of production and can uniformly form a plated layer over an entire circumference of the female terminal excluding an electric wire.

According to an embodiment, there is provided a method of manufacturing a female terminal including: forming a cutout part with a predetermined width in a direction intersecting with an axial direction of a tubular member, on a part of a first tubular portion located at a side of a first end of the tubular member, crushing the first tubular portion to form an electric wire connection portion, and forming as a terminal contact portion a second tubular portion located at a side of a second end of the tubular member, wherein a male terminal is to be inserted in the terminal contact portion; and electrically connecting a core wire exposed from an end of an electric wire to the electric wire connection portion.

According to an embodiment, the method further includes plating an entire circumference of the electric wire connection portion and the terminal contact portion to form a plated layer.

According to an embodiment, the core wire of the electric wire is electrically connected to the electric wire connection portion formed into a flat shape by crushing the first tubular portion, by ultrasonic bonding.

According to an embodiment, it is possible to provide a method of manufacturing a female terminal that can reduce a manufacturing cost to lower a cost of production and can uniformly form a plated layer over an entire circumference of the female terminal excluding an electric wire.

### BRIEF DESCRIPTION OF THE DRAWINGS

FIG. 1 is a perspective view of a round tube member used in a method of manufacturing a female terminal according to an embodiment.

FIG. 2 is a side view illustrating a state where a cutout part is formed on a part of a round tubular portion located at a side of one end of the round tube member.

FIG. 3 is a perspective view illustrating a state where a round tubular portion located at the side of the one end of the round tube member is crushed.

FIG. 4 is a side view illustrating a state before a core wire of an electric wire is connected to a portion, which serves as an electric wire connection portion, where the round tubular portion located at the side of the one end of the round tube member is crushed.

FIG. 5 is a side view illustrating a state where the core wire of the electric wire is connected to the electric wire connection portion.

### DETAILED DESCRIPTION

A method of manufacturing a female terminal according to various embodiments will be described below with reference to the accompanying drawings. Note that the dimensional ratios in the drawings are exaggerated for convenience of explanation and may differ from the actual ratios.

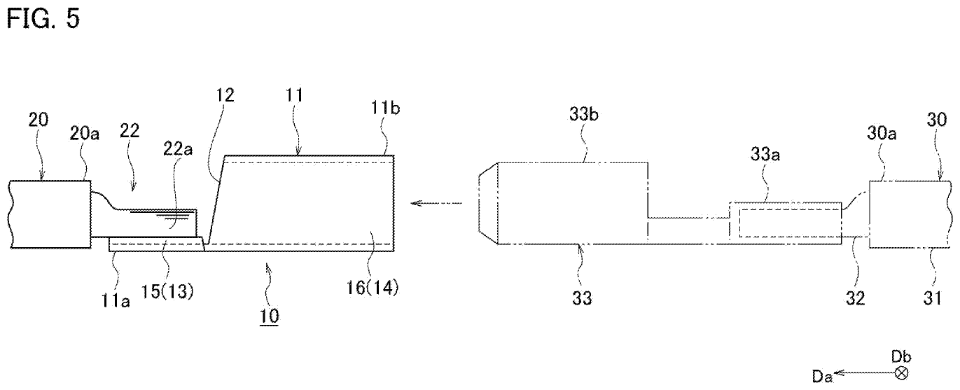

As illustrated in FIG.5, a female terminal 10 includes a round tube member 11 (tubular member) with a crushed portion. The round tube member 11 with the crushed portion is also referred to as a partly-crushed round tube member 11. The female terminal 10 has an electric wire connection portion 15 at a side of one end 11a (first end) of the partly-crushed round tube member 11. The female terminal 10 has a terminal contact portion 16 at a side of the other end 11b (second end) of the partly-crushed round tube member 11. A core wire 22 exposed from an end 20a of an electric wire 20 is electrically connected to the electric wire connection portion 15. A male terminal 33 crimped to an end 30a of an electric wire 30 is to be inserted in the terminal contact portion 16. The female terminal 10 is a female terminal with an electric wire.

As illustrated in FIGS. 2 and 4, a cutout part 12 with a predetermined width is formed in a direction Db vertically intersecting with an axial direction Da of the round tube member 11, on a part of a round tubular portion 13 (first tubular portion) located at the side of the one end 11a (first end) of the round tube member 11. The electric wire connection portion 15 is formed on at the side of the one end 11a of the round tube member 11 by crushing the round tubular portion 13. The terminal contact portion 16 is formed at the side of the other end 11b (second end) of the round tube member 11 by leaving a round tubular portion 14 (second tubular portion) located at the side of the other end 11b of the round tube member 11, which is a remaining portion of the round tube member 11 excluding a portion (electric wire connection portion 15) where the round tubular portion 13 is crushed, in its original shape. A cylindrical tab portion 33b of the male terminal 33 is to be inserted in the terminal contact portion 16 to contact the terminal contact portion 16.

As illustrated in FIGS. 4 and 5, the electric wire 20 has an insulation coating 21 and the core wire (conductor) 22 including a plurality of strands 22a twisted together. The core wire 22 is covered with the insulation coating 21. The core wire 22, which is exposed by peeling off the insulation coating 21 on a side of the end 20a of the electric wire 20, is electrically connected to the electric wire connection portion 15 by ultrasonic bonding. Note that as specific materials of the core wire 22, copper or a copper-based copper alloy, or aluminum or an aluminum-based aluminum alloy can be mentioned.

As illustrated in FIG. 5, the electric wire 30 has an insulation coating 31 and the core wire (conductor) 32 including a plurality of strands twisted together. The core wire 32 is covered with the insulation coating 31. A crimping portion 33a of the male terminal 33 is crimped and connected to the core wire 32, which is exposed by peeling off the insulation coating 31 on a side of the end 30a of the electric wire 30. The cylindrical tab portion 33b of the male terminal 33 is inserted in the cylindrical terminal contact portion 16 of the female terminal 10 to be electrically connected to the terminal contact portion 16 of the female terminal 10. Note that as specific materials of each of the core wire 32 and the male terminal 33, copper or a copper-based copper alloy, or aluminum or an aluminum-based aluminum alloy can be mentioned.

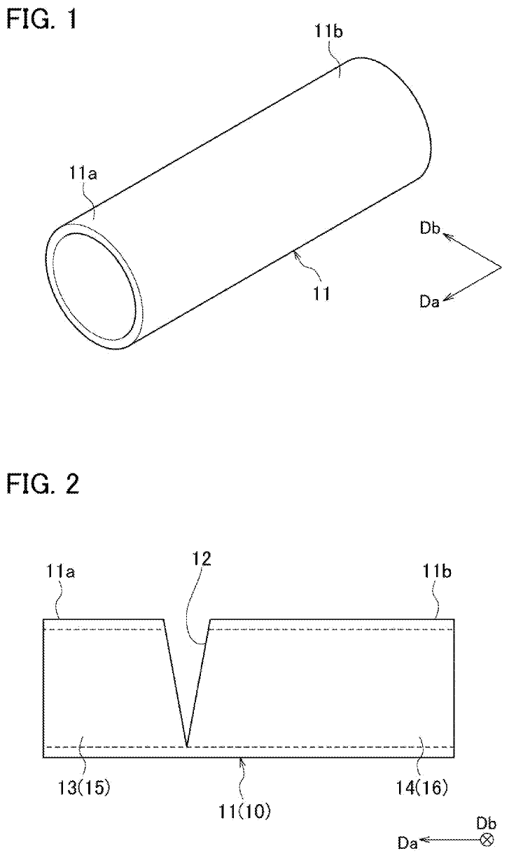

Next a method of manufacturing of the female terminal 10 will be describe along FIGS. 1 to 4.

First of all, the round tube member 11 as the tubular member is prepared, as illustrated in FIG. 1. The round tube member 11 is formed into a cylindrical shape with a perfect circle and is made of a material with excellent conductivity such as a metal. The specific materials of the round tube member 11 include a conductive metal tube such as copper or a copper-based copper alloy, or aluminum or an aluminum-based aluminum alloy. Furthermore, the round tube member 11 may be made of a member produced by forming a metal plate into a cylindrical shape by press forming.

Although the round tube member 11 formed into a cylindrical shape is used as the tubular member as described above, a shape of the tubular member is not limited to the cylindrical shape. The shape of the tubular member may be an elliptical tube shape or a square tube shape.

Next, as illustrated in FIG. 2, a part of the round tubular portion 13 located at the side of the one end 11a of the round tube member 11 is cut in a V-shape as viewed from the direction Db vertically intersecting with the axial direction Da of the round tube member 11, to form the cutout part 12 with a predetermined width. A V-shaped tip (depth) of the cutout part 12 is located in the vicinity of a bottom of the round tubular portion 13 at the side of the one end 11a of the round tube member 11. In other words, the cutout part 12 extends to the vicinity of the bottom of the round tubular portion 13. Then, the round tubular portion 13 at the side of the one end 11a of the round tube member 11 is crushed from above downward to form the electric wire connection portion 15. For example, a crushing direction is a depth direction of the cutout part 12. The round tubular portion 14 at the side of the other end 1 lb of the round tube member 11 becomes the terminal contact portion 16 in which the cylindrical tab portion 33b of the male terminal 33 is to be inserted.

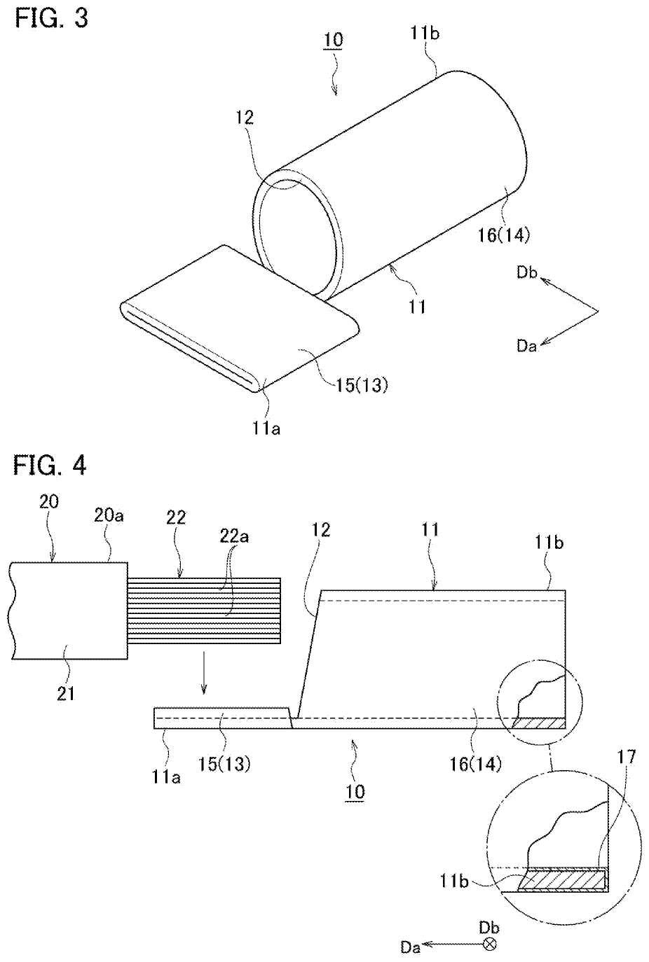

Then, as illustrated in FIG. 3, the entire circumference of the portion (flat electric wire connection portion 15) where the round tubular portion 13 is crushed at the side of the one end 11a of the round tube member 11, and the round tube portion 14 (terminal contact portion 16) at the side of the other end 11b of the round tube member 11, are plated to form a plating layer 17 such as a tin plating layer. Thus, the entire circumference of the round tube member 11 is plated to from the plating layer 17.

Then, as illustrated in FIG. 4, the core wire 22 exposed from the end 20a of the electric wire 20 is electrically connected to the electric wire connection portion 15 formed into a flat shape by crushing the round tubular portion 13 at the side of the one end 11a of the round tube member 11, by ultrasonic bonding, thereby completing the female terminal 10 with the electric wire illustrated in FIG. 5.

In the method of manufacturing of the female terminal 10, the round tubular portion 13 at the side of the one end 11a of the round tube member 11 is crushed to form the electric wire connection portion 15. The round tubular portion 14 at the side of the other end 11b of the round tube member 11 is used as the terminal contact portion 16 in which the tab portion 33b of the male terminal 33 is to be inserted. Therefore, it is not necessary to perform the conventional hollowing of a solid cylindrical member.

Further, since the round tubular portion 14, which is formed into a non-bottomed hole at the side of the other end 11b of the round tube member 11, is used as the terminal contact portion 16. This configuration allows a plating solution to flow without stagnating when this portion is plated. In other words, by forming the V-shaped cutout part 12 on a part of the round tubular portion 13 located at the side of the one end 11a of the round tube member 11 and crushing the round tubular portion 13, the plating solution can easily circulate around the outside, inside, front and back of the round tube member 11, which allows additives in the plating solution to be evenly applied.

Furthermore, as illustrated in FIGS. 3 and 4, a thickness of the electric wire connection portion 15 is reinforced by the crushing of the round tubular portion 13 at the side of the one end 11a to twice a wall thickness of the terminal contact portion 16, so that it is strong enough to withstand the ultrasonic bonding of the core wire 22 of the electric wire 20. As a result, the core wire 22 of the electric wire 20 can be electrically connected to the electric wire connection portion 15 by ultrasonic bonding, securely.

Thus, it is not necessary to perform the conventional hollowing of a solid cylindrical member, which reduces a manufacturing cost of the female terminal 10 to lower a cost of production. The round tube member 11 is plated after the cutout part 12 is formed on a part of the round tubular portion 13 located at the side of the one end 11a of the round tube member 11 and the round tubular portion 13 is crushed, which uniformly forms the plated layer 17 over an entire circumference of the round tube member 11.

Although the embodiment is described above, the disclosure is not limited to these. Various modifications are possible within the scope of the gist of the disclosure.

For example, in the above-described embodiment, a part of the round tubular portion 13 located at the side of the one end 11a of the round tube member 11 is cut in a V-shape as viewed from the direction Db vertically intersecting with the axial direction Da of the round tube member 11, to form the cutout part 12 with a predetermined width. A shape of the cutout part 12 is not limited to the V-shape, and may be a linear shape or a slit shape as viewed from the direction Db vertically intersecting with the axial direction Da of the round tube member 11.

In the above-described embodiment, as the tubular member, the cylindrical female terminal 10 is formed using the round tube member 11. Instead of the cylindrical female terminal, a square tube female terminal may be formed using a squire tube member. In this case, the cylindrical female terminal and the square tube female terminal can be used separately according to the layout (specifications) of the connector.

Furthermore, in the above-described embodiment, the entire circumference of the round tube member 11 is plated. The entire circumference of the round tube member 11 excluding the electric wire connection portion 15 to which the core wire 22 of the electric wire 20 is to be connected, may be plated.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of manufacturing a female terminal comprising:
forming a cutout part with a predetermined width in a direction intersecting with an axial direction of a tubular member, on a part of a first tubular portion located at a side of a first end of the tubular member, crushing the first tubular portion to form an electric wire connection portion, and forming as a terminal contact portion a second tubular portion located at a side of a second end of the tubular member,
wherein a male terminal is to be inserted in the terminal contact portion; and
electrically connecting a core wire exposed from an end of an electric wire to the electric wire connection portion.

2. The method according to claim 1, further comprising
plating an entire circumference of the electric wire connection portion and the terminal contact portion to form a plated layer.

3. The method according to claim 1, wherein
the core wire of the electric wire is electrically connected to the electric wire connection portion formed into a flat shape by crushing the first tubular portion, by ultrasonic bonding.
